(19) United States
(12) Patent Application Publication
(10) Pub. No.: US 2018/0173047 A1
(43) Pub. Date: Jun. 21, 2018

(54) COLOR FILM SUBSTRATE ASSEMBLY AND METHOD OF MANUFACTURING THE SAME, AND DISPLAY APPARATUS

(71) Applicant: BOE TECHNOLOGY GROUP CO., LTD., Beijing (CN)

(72) Inventor: Miki Kashima, Beijing (CN)

(21) Appl. No.: 15/738,095

(22) PCT Filed: May 3, 2017
(86) PCT No.: PCT/CN2017/082856

§ 371 Date: Dec. 19, 2017

(30) Foreign Application Priority Data
May 16, 2016 (CN) 201610324334.3

(51) Int. Cl. G02F 1/1335; G02F 1/1343; G02F 1/1333

(52) U.S. Cl. CPC G02F 1/133516; G02F 1/13439; G02F 2203/055; G02F 2201/52; G02F 2203/10; G02F 1/133345

(57) ABSTRACT

Embodiments of the present disclosure disclose a color film substrate assembly and a method of manufacturing the same, and a display apparatus, and pertain to the field of display technology. In an embodiment, the color film substrate assembly includes: a first substrate and a color film layer formed on a first surface of the first substrate; wherein, the color film layer is provided with a plurality of types of transmissive patterns distributed periodically, each transmissive pattern in a same type of transmissive patterns is constituted by a plurality of holes being in an array arrangement and having hole diameters in one hole diameter range, holes in the plurality of types of transmissive patterns have hole diameters in different hole diameter ranges, and the same type of transmissive patterns is capable of transmitting a light of one color therethrough.

### CROSS-REFERENCE TO RELATED APPLICATION

This application is a 371 National Stage application of International Application No. PCT/CN2017/082856, with an international filing date of May 3, 2017, which has not yet published, and which claims priority to Chinese Patent Application No. 201610324334.3 filed on May 16, 2016 in the State Intellectual Property Office of China, the present disclosures of which are hereby incorporated by reference in their entirety.

### TECHNICAL FIELD

Embodiments of the present disclosure relate to the field of display technology, and particularly, to a color film substrate assembly and a method of manufacturing the same, and a display apparatus.

### BACKGROUND

In order to achieve a color display, a color film layer is generally disposed inside a display apparatus. The color film layer usually comprises a pattern formed by resin materials of various colors, and lights of different colors can be obtained through filtering out of the resin materials of the various colors. However, this color film layer has a low transmissivity.

### SUMMARY

According to a first aspect of embodiments of the present disclosure, there is provided a color film substrate assembly, comprising: a first substrate and a color film layer formed on a first surface of the first substrate;

wherein, the color film layer is provided with a plurality of types of transmissive patterns distributed periodically, and each transmissive pattern in a same type of transmissive patterns is constituted by a plurality of holes being in an array arrangement and having hole diameters in one hole diameter range, holes in the plurality of types of transmissive patterns have hole diameters in different hole diameter ranges, and the same type of transmissive patterns is capable of transmitting a light of one color therethrough.

In an embodiment of the present disclosure, the color film layer is a metal layer formed of a metal material.

In an embodiment of the present disclosure, the metal material comprises at least one of aluminum, gold, silver, platinum, copper, nickel, palladium, zinc, iron and chromium.

In an embodiment of the present disclosure, the color film layer has a thickness of about 100 nm˜about 300 nm.

In an embodiment of the present disclosure, the holes have a shape of a circle or a regular polygon.

In an embodiment of the present disclosure, the plurality of types of transmissive patterns comprise a red light transmissive pattern, a blue light transmissive pattern and a green light transmissive pattern.

In an embodiment of the present disclosure, the holes constituting the red light transmissive pattern have hole diameters in a hole diameter range of about 400 nm˜about 470 nm, the holes constituting the green light transmissive pattern have hole diameters in a hole diameter range of about 280 nm˜about 310 nm, and, the holes constituting the blue light transmissive pattern have hole diameters in a hole diameter range of about 200 nm˜about 270 nm.

According to a second aspect of embodiments of the present disclosure, there is provided a display apparatus, comprising: the color film substrate assembly according to any one of the embodiments in the first aspect, a liquid crystal cell and a backlight source; wherein,

the color film substrate assembly is between the liquid crystal cell and the backlight source.

In an embodiment of the present disclosure, the liquid crystal cell comprises a second substrate, a third substrate, a first electrode layer, a second electrode layer and a liquid crystal layer;

the first electrode layer is on a surface of the third substrate facing towards the second substrate, the second electrode layer is on a surface of the second substrate facing towards the third substrate, and the liquid crystal layer is between the first electrode layer and the second electrode layer.

In an embodiment of the present disclosure, a first surface of the first substrate faces towards the backlight source; or,

the first surface of the first substrate faces away from the backlight source.

In an embodiment of the present disclosure, the liquid crystal cell comprises the first substrate, a second substrate, a first electrode layer, a second electrode layer and a liquid crystal layer;

the first electrode layer is on a second surface of the first substrate, the second surface and the first surface being two opposite surfaces of the first substrate, the second electrode layer is on a surface of the second substrate facing towards the first substrate, and the liquid crystal layer is between the first electrode layer and the second electrode layer.

In an embodiment of the present disclosure, the liquid crystal cell comprises the first substrate, an insulation layer, a second substrate, a first electrode layer, a second electrode layer and a liquid crystal layer;

the insulation layer is on a first surface of the first substrate, the first electrode layer is on the insulation layer, the second electrode layer is on a surface of the second substrate facing towards the first substrate, and the liquid crystal layer is between the first electrode layer and the second electrode layer.

In an embodiment of the present disclosure, the first electrode layer and the second electrode layer are transparent electrode layers.

In an embodiment of the present disclosure, the liquid crystal layer is formed by polymerizing a composition comprising negative liquid crystals, polymerizable monomers and a photoinitiator.

According to a third aspect of embodiments of the present disclosure, there is provided a method of manufacturing a color film substrate assembly, the method comprises:

providing a first substrate; and

forming a color film layer on a first surface of the first substrate, wherein, the color film layer is provided with a plurality of types of transmissive patterns distributed periodically, and each transmissive pattern in the same type of transmissive patterns is constituted by holes being in an array arrangement and having hole diameters in one hole diameter range, the holes in the plurality of types of transmissive patterns have hole diameters in different hole diameter ranges, and the same type of transmissive patterns is capable of transmitting a light of one color therethrough.

In an embodiment of the present disclosure, the step of forming a color film layer on a first surface of the first substrate, further comprises:

coating a metal layer onto the first surface of the first substrate; and

etching holes, which have hole diameters in a plurality of hole diameter ranges, in the metal layer, to obtain the plurality of types of transmissive patterns.

In an embodiment of the present disclosure, the plurality of types of transmissive patterns comprise a red light transmissive pattern, a blue light transmissive pattern and a green light transmissive pattern.

In an embodiment of the present disclosure, the holes constituting the red light transmissive pattern have hole diameters in a hole diameter range of about 400 nm˜about 470 nm, the holes constituting the green light transmissive pattern have hole diameters in a hole diameter range of about 280 nm˜about 310 nm, and, the holes constituting the blue light transmissive pattern have hole diameters in a hole diameter range of about 200 nm˜about 270 nm.

disclosure

### BRIEF DESCRIPTION OF THE DRAWINGS

In order to provide a more clear explanation of technical solutions in embodiments of the present disclosure, there is provided a brief introduction of the attached drawings used in the following description of the embodiments. Obviously, the drawings mentioned in the following description only belong to some embodiments of the present disclosure. However, for those skilled in the art, other drawings may be achieved on the basis of these attached drawings without involving any inventive steps.

FIG. 1 is a schematic view showing a structure of a color film substrate assembly according to an embodiment of the present disclosure;

FIG. 2 is a schematic view showing a structure of a type transmissive pattern according to an embodiment of the present disclosure;

FIG. 3 is a schematic view showing a structure of types of transmissive patterns according to another embodiment of the present disclosure;

FIG. 4 is a schematic view showing a structure of a display apparatus according to an embodiment of the present disclosure;

FIG. 5 is a schematic view showing a structure of the display apparatus according to the embodiment of the present disclosure;

FIG. 6 is a schematic view showing a structure of a display apparatus according to another embodiment of the present disclosure;

FIG. 7 is a schematic view showing a structure of a display apparatus according to still another embodiment of the present disclosure; and

FIG. 8 is a flow diagram showing a method of manufacturing a color film substrate assembly according to an embodiment of the present disclosure.

### DETAILED DESCRIPTION OF THE EMBODIMENTS

In order to provide a more clear understanding of objects, technique solutions and advantages of embodiments of the present disclosure, the embodiments of the present disclosure will be further described hereinafter in detail and completely with reference to the attached drawings.

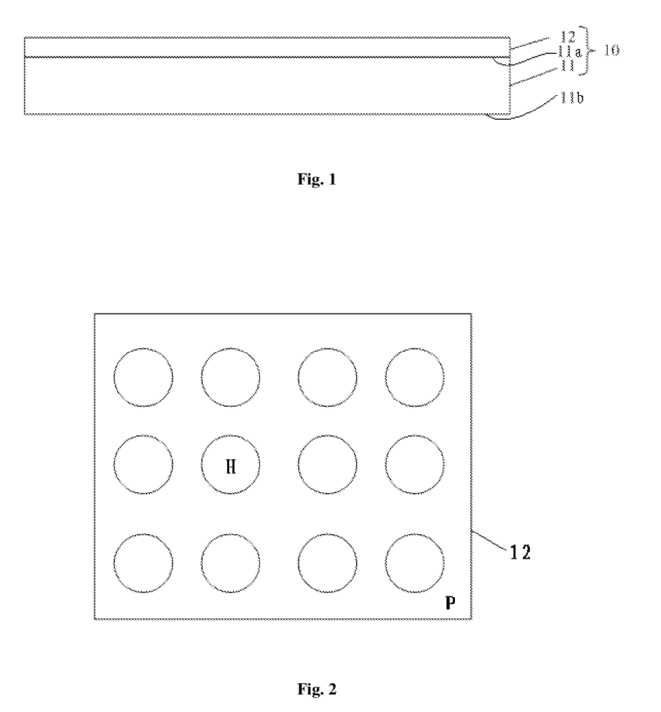

Referring to FIG. 1, embodiments of the present disclosure provide a color film substrate assembly 10. The color film substrate assembly 10 comprises: a first substrate 11 and a color film layer 12 formed on a first surface 11a of the first substrate 11. The first surface is any one of main surfaces of the first substrate 11. Referring to FIG. 2, the color film layer 12 is provided with a plurality of types of transmissive patterns P distributed periodically, each transmissive pattern in a same type of transmissive patterns P is constituted by a plurality of holes H being in an array arrangement and having hole diameters in one hole diameter range, holes in the plurality of types of transmissive patterns P have hole diameters in different hole diameter ranges, and the same type of transmissive patterns P is capable of transmitting a light of one color therethrough.

In the color film substrate assembly according to embodiments of the present disclosure, the color film layer is provided with a plurality of types of transmissive patterns distributed periodically and each type of transmissive patterns is capable of transmitting a light of one color therethrough. In this way, when a light emitted from a backlight source passes through the color film layer, lights of different colors are transmitted through holes having hole diameters in different hole diameter ranges such that the light of each color has a good transmissivity, thereby enhancing a display effect.

On the basis of the structure of the color film substrate assembly shown in FIG. 1, another embodiment of the present disclosure provides a color film substrate assembly 10. In the color film substrate assembly 10, the color film layer 12 may be a metal layer formed of a metal material, and the metal material may comprise at least one of aluminum, gold, silver, platinum, copper, nickel, palladium, zinc, iron and chromium, and the like. The color film layer 12 made of metal material is a Plasmonic Color Film (Plasmonic CF), which not only has a greatly high reflectivity to own a good mirror display function, but also achieves transmitting of lights of different colors through holes having hole diameters in different hole diameter ranges, by utilizing plasmonic resonance effect of a metal surface.

As an alternative embodiment, generally the color film layer 12 may have a thickness of 100 nm˜300 nm.

As an alternative embodiment, the holes H in the types of transmissive patterns have a shape of circle or regular polygon. In the shown embodiment, the holes H have a shape of circle.

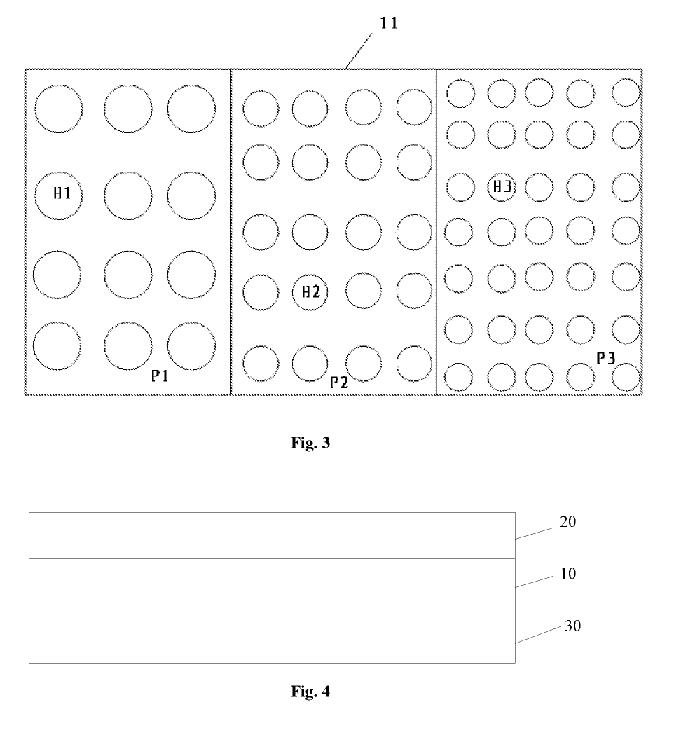

As an alternative embodiment, referring to FIG. 3, the plurality of types of transmissive patterns may comprise a red light transmissive pattern P1, a blue light transmissive pattern P3 and a green light transmissive pattern P2, etc.. Each transmissive pattern is capable of transmitting a light of one color therethrough. For example, the red light transmissive pattern is capable of transmitting red light therethrough, the blue light transmissive pattern is capable of transmitting blue light therethrough, and the green light transmissive pattern is capable of transmitting green light therethrough. Because lights of different colors have different wavelengths, hole diameter ranges required for lights of different colors to be transmitted through the holes of the types of transmissive patterns are different. Generally, the holes H1 in the red light transmissive pattern P1 have hole diameters in a maximum hole diameter range, the holes H2 in the green light transmissive pattern P2 have hole diameters in a less hole diameter range than the holes H1 in the red light transmissive pattern P1, and the holes H3 in the blue light transmissive pattern P3 have hole diameters in a minimum hole diameter range. In the present embodiment, the holes H1 constituting the red light transmissive pattern P1 have hole diameters in a hole diameter range of about 400 nm˜about 470 nm, the holes H2 constituting the green light transmissive pattern P2 have hole diameters in a hole diameter range of about 280 nm˜about 310 nm, and, the holes H3 constituting the blue light transmissive pattern P3 have hole diameters in a hole diameter range of about 200 nm˜about 270 nm. FIG. 3 is a schematic view showing different types of transmissive patterns of the color film layer 12, in which the transmissive pattern at the left side is the red light transmissive pattern P1, the transmissive pattern in the middle is the green light transmissive pattern P2, and the transmissive pattern at the right side is the blue light transmissive pattern P3.

As an alternative embodiment, in order to prevent the holes in the types of transmissive patterns from being damaged, referring to FIG. 3a, the color film layer 12 may further be provided with a protective layer 13, for example, the protective layer may be a silicon oxide layer.

In the color film substrate assembly according to embodiments of the present disclosure, the color film layer is provided with a plurality of types of transmissive patterns distributed periodically, and the same type of transmissive patterns is capable of transmitting a light of one color therethrough. In this way, when a light emitted from a backlight source passes through the color film layer, lights of different colors are transmitted through holes having hole diameters in different hole diameter ranges such that the light of each color has a good transmissivity, thereby enhancing a display effect.

It should be noted that, the color film substrate assembly according to these embodiments of the present disclosure necessarily further comprises, in addition to the abovementioned first substrate 11 and color film layer 12, various elements and layer structures that serve as essential components of a color film substrate assembly, for example, photoresist and the like. However, for the sake of brevity, descriptions and explanations on these elements and layer structures are omitted.

Referring to FIG. 4, embodiments of the present disclosure provide a display apparatus, and the display apparatus comprises: the color film substrate assembly 10 shown in FIG. 1, a liquid crystal cell 20 and a backlight source 30. The color film substrate assembly 10 is between the liquid crystal cell 20 and the backlight source 30.

In practical applications, the display apparatus can be any products and components having a display function, including a liquid crystal display panel, a smart mobile phone, a tablet computer, a smart TV, a desktop computer, a digit photo frame, a navigator and the like.

In the display apparatus according to the present embodiment, the color film layer of the color film substrate assembly is provided with a plurality of types of transmissive patterns distributed periodically and the same type of transmissive patterns is capable of transmitting a light of one color therethrough. In this way, when a light emitted from a backlight source passes through the color film layer, lights of different colors are transmitted through holes having hole diameters in different hole diameter ranges such that the light of each color has a good transmissivity, thereby enhancing a display effect.

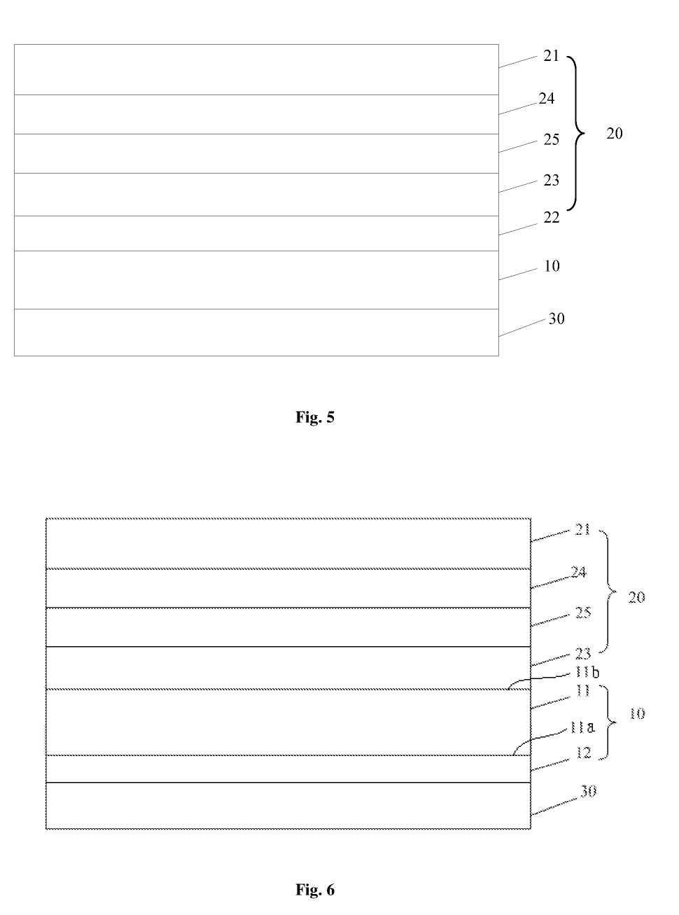

On the basis of the display apparatus shown in FIG. 4, another embodiment of the present disclosure provides a display apparatus. Referring to FIG. 5, the liquid crystal cell 20 of the display apparatus comprises a second substrate 21, a third substrate 22, a first electrode layer 23, a second electrode layer 24 and a liquid crystal layer 25. Referring to FIG. 5, the first electrode layer 23 is on a surface of the third substrate 22 facing towards the second substrate 21, the second electrode layer 24 is on a surface of the second substrate 21 facing towards the third substrate 22, and the liquid crystal layer 25 is between the first electrode layer 23 and the second electrode layer 24.

In the present embodiment, the first surface 11a of the first substrate 11 shown in FIG. 1 may face towards the backlight source 30, or the first surface 11a of the first substrate 11 may also face away from the backlight source 30.

As an alternative embodiment, the first electrode layer 23 and the second electrode layer 24 may be transparent electrode layers.

As an alternative embodiment, the liquid crystal layer 25 may be composed of liquid crystals having negative dielectric anisotropy (negative liquid crystals), polymerizable monomers and a photoinitiator and the like. In accordance with a difference between refractive indexes of the liquid crystal and the polymer, in a case that no voltage is applied, the liquid crystal layer 25 is in a transparent state and can be served as a transparent functional film material; and in a case that a voltage is applied, the liquid crystal layer 25 is in a non-transparent state and can be served as a non-transparent functional film material.

The display apparatus shown in FIG. 5 has the following operating principle.

In a case that no voltage is applied, the backlight source 30 is in a turn-off condition, the liquid crystal layer 25 is in a transparent state, and the color film layer 12 of the color film substrate assembly 10 can reflect ambient light, obtaining a mirror function; and in a case that a voltage is applied, a light emitted from the backlight source 30 becomes lights of different colors after passing through the color film layer 12, and the transmitted lights are controlled in transmissivity by the liquid crystal layer 25, achieving a good display effect.

In the display apparatus according to embodiments of the present disclosure, the color film layer of the color film substrate assembly is provided with a plurality of types of transmissive patterns distributed periodically and the same type of transmissive patterns is capable of transmitting a light of one color therethrough. In this way, when a light emitted from a backlight source passes through the color film layer, lights of different colors are transmitted through holes hole diameters in having different hole diameter ranges such that the light of each color has a good transmissivity, thereby enhancing a display effect.

On the basis of the display apparatus shown in FIG. 4, another embodiment of the present disclosure provides a display apparatus. Referring to FIG. 6, the liquid crystal cell 20 of the display apparatus comprises a first substrate 11, a second substrate 21, a first electrode layer 23, a second electrode layer 24 and a liquid crystal layer 25. Referring to FIG. 6, the first electrode layer 23 is on a second surface 11b of the first substrate 11, the color film layer 12 is on a first surface 11a of the first substrate 11, the second surface 11b and the first surface 11a are two opposite surfaces of the first substrate 11, the second electrode layer 24 is on a surface of the second substrate 21 facing towards the first substrate 11, and the liquid crystal layer 25 is between the first electrode layer 23 and the second electrode layer 24.

As an alternative embodiment, the first electrode layer 23 and the second electrode layer 24 may be transparent electrode layers.

As an alternative embodiment, the liquid crystal layer 25 may be composed of liquid crystals having negative dielectric anisotropy (negative liquid crystals), polymerizable monomers and a photoinitiator and the like. In accordance with a difference between refractive indexes of the liquid crystal and the polymer, in a case that no voltage is applied, the liquid crystal layer 25 is in a transparent state and can be served as a transparent functional film material; and in a case that a voltage is applied, the liquid crystal layer 25 is in a non-transparent state and can be served as a non-transparent functional film material.

The display apparatus shown in FIG. 6 has the following operating principle.

In a case that no voltage is applied, the backlight source 30 is in a turn-off condition, the liquid crystal layer 25 is in a transparent state, and the color film layer 12 of the color film substrate assembly 10 can reflect ambient light, obtaining a mirror function; and in a case that a voltage is applied, a light emitted from the backlight source 30 becomes lights of different colors after passing through the color film layer 12, and the transmitted lights are controlled in transmissivity by the liquid crystal layer 25, achieving a good display effect.

In the display apparatus according to the present embodiment, the color film layer of the color film substrate assembly is provided with a plurality of types of transmissive patterns distributed periodically and the same type of transmissive patterns is capable of transmitting a light of one color therethrough. In this way, when a light emitted from a backlight source passes through the color film layer, lights of different colors are transmitted through holes having hole diameters in different hole diameter ranges such that the light of each color has a good transmissivity, thereby enhancing a display effect.

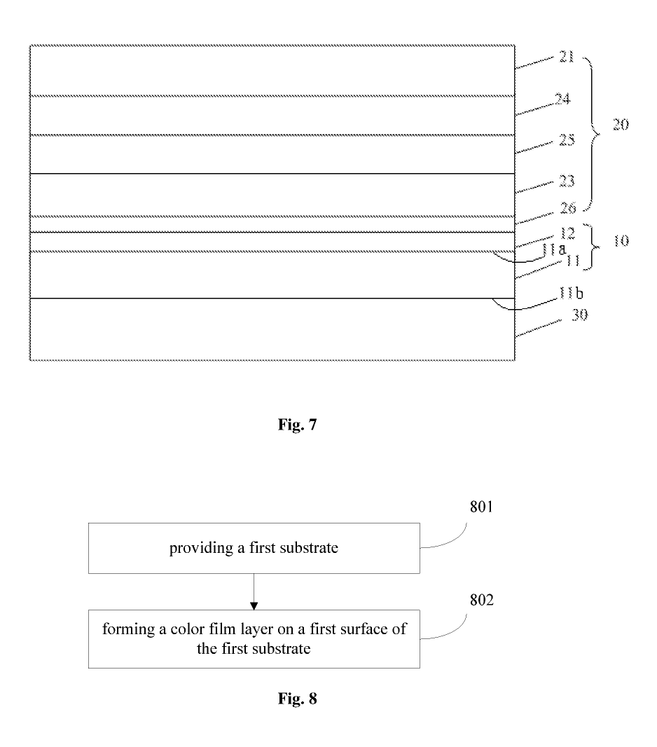

On the basis of the display apparatus shown in FIG. 4, another embodiment of the present disclosure provides a display apparatus. Referring to FIG. 7, the liquid crystal cell 20 of the display apparatus comprises a first substrate 11, an insulation layer 26, a second substrate 21, a first electrode layer 23, a second electrode layer 24 and a liquid crystal layer 25. Referring to FIG. 7, the insulation layer 26 is on the color film layer 12 located at the first surface 11a of the first substrate 11, the first electrode layer 23 is on the insulation layer 26, the second electrode layer 24 is on a surface of the second substrate 21 facing towards the first substrate 11, and the liquid crystal layer 25 is between the first electrode layer 23 and the second electrode layer 24.

As an alternative embodiment, the first electrode layer 23 and the second electrode layer 24 may be transparent electrode layers.

As an alternative embodiment, the liquid crystal layer 25 may be composed of liquid crystals having negative dielectric anisotropy (negative liquid crystals), polymerizable monomers and a photoinitiator and the like. In accordance with a difference between refractive indexes of the liquid crystal and the polymer, in a case that no voltage is applied, the liquid crystal layer 25 is in a transparent state and can be served as a transparent functional film material; and in a case that a voltage is applied, the liquid crystal layer 25 is in a non-transparent state and can be served as a non-transparent functional film material.

The display apparatus shown in FIG. 7 has the following operating principle.

In a case that no voltage is applied, the backlight source 30 is in a turn-off condition, the liquid crystal layer 25 is in a transparent state, and the color film layer 12 of the color film substrate assembly 10 can reflect ambient light, obtaining a mirror function; and in a case that a voltage is applied, a light emitted from the backlight source 30 becomes lights of different colors after passing through the color film layer 12, and the transmitted lights are controlled in transmissivity by the liquid crystal layer 25, achieving a good display effect.

In the display apparatus according to the present embodiment, the color film layer of the color film substrate assembly is provided with a plurality of types of transmissive patterns distributed periodically and the same type of transmissive patterns is capable of transmitting a light of one color therethrough. In this way, when a light emitted from a backlight source passes through the color film layer, lights of different colors are transmitted through holes having hole diameters in different hole diameter ranges such that the light of each color has a good transmissivity, thereby enhancing a display effect.

It should be noted that, the display apparatus according to these embodiments of the present disclosure necessarily further comprises, in addition to the abovementioned color film substrate assembly 10, liquid crystal cell 20 and backlight source 30, various elements and layer structures that serve as essential components of a display apparatus, for example, array substrate and the like. However, for the sake of brevity, descriptions and explanations on these elements and layer structures are omitted.

Embodiments of the present disclosure provide a method of manufacturing a color film substrate assembly. Referring to FIG. 8, the method of manufacturing a color film substrate assembly mainly comprises:

a step 801 of providing a first substrate; and

a step 802 of forming a color film layer on a first surface of the first substrate.

In the step 801, the first substrate may be a glass substrate, a quartz substrate and the like. Types of the first substrate are not specifically limited in the present embodiment.

In a specific embodiment of the present disclosure, the above step 802 may further comprise the following sub-steps.

A metal layer is coated onto the first surface of the first substrate. It is appropriate that a thickness of the metal layer is in the range of about 100 nm˜about 300 nm. The metal coated includes at least one of aluminum, gold, silver, platinum, copper, nickel, palladium, zinc, iron and chromium. Preferably, metal aluminum is used.

A layer of photosensitive resist is coated onto the first surface, formed with the metal layer, of the first substrate.

With a mask, an exposing process is implemented on the first surface, coated with the photosensitive resist, of the first substrate, to form a photosensitive resist completely-removed region and a photosensitive resist completely-reserved region.

After the exposing process is implemented, the first surface of the first substrate is etched using a metal etching liquid, to form a color film layer on the first surface of the first substrate. The color film layer is provided with a plurality of types of transmissive patterns distributed periodically, and each transmissive pattern in a same type of transmissive patterns is constituted by a plurality of holes being in an array arrangement and having hole diameters in one hole diameter range, holes in the plurality of types of transmissive patterns have hole diameters in different hole diameter ranges, and the same type of transmissive patterns is capable of transmitting a light of one color therethrough. In one embodiment, the abovementioned plurality of types of transmissive patterns comprise a red light transmissive pattern, a blue light transmissive pattern and a green light transmissive pattern, etc.. The holes constituting the red light transmissive pattern have hole diameters in a hole diameter range of about 400 nm˜about 470 nm, the holes constituting the green light transmissive pattern have hole diameters in a hole diameter range of about 280 nm˜about 310 nm, and, the holes constituting the blue light transmissive pattern have hole diameters in a hole diameter range of about 200 nm˜about 270 nm.

In addition, in order to prevent the holes in the transmissive pattern from being damaged, the method according to the present embodiment may further comprise a step of coating a protective layer onto a surface of the metal layer, for example, the protective layer is a silicon oxide film.

In the method of manufacturing the color film substrate assembly according to embodiments of the present disclosure, the color film layer of the color film substrate assembly is provided with a plurality of types of transmissive patterns distributed periodically and the same type of transmissive patterns is capable of transmitting a light of one color therethrough. In this way, when a light emitted from a backlight source passes through the color film layer, lights of different colors are transmitted through holes having hole diameters in different hole diameter ranges such that the light of each color has a good transmissivity, thereby enhancing a display effect.

It should be noted that, the method of manufacturing the color film substrate assembly according to these embodiments of the present disclosure necessarily further comprises, in addition to the abovementioned steps, steps of manufacturing various elements and layer structures that serve as essential components of a color film substrate assembly. However, for the sake of brevity, descriptions and explanations on these manufacturing steps are omitted.

The above are merely preferable embodiments of the present disclosure, but not to limit the present disclosure. Any changes, equivalent replacements and modifications made without departing from the principles and spirit of the present disclosure fall into the scope of the present disclosure.

1. A color film substrate assembly, comprising:
a first substrate; and
a color film layer formed on a first surface of the first substrate;
wherein, the color film layer is provided with a plurality of types of transmissive patterns distributed periodically, and each of the transmissive patterns in a same type of transmissive patterns is constituted by a plurality of holes being in an array arrangement and having hole diameters in one hole diameter range, holes in the plurality of types of transmissive patterns have hole diameters in different hole diameter ranges, and each of the same type of transmissive patterns is capable of transmitting a light of one color therethrough.

2. The color film substrate assembly of claim 1, wherein, the color film layer is a metal layer formed of a metal material.

3. The color film substrate assembly of claim 2, wherein, the metal material comprises at least one of aluminum, gold, silver, platinum, copper, nickel, palladium, zinc, iron and chromium.

4. The color film substrate assembly of claim 1, wherein, the color film layer has a thickness of about 100 nm˜about 300 nm.

5. The color film substrate assembly of claim 1, wherein, the holes have a shape of a circle or a regular polygon.

6. The color film substrate assembly of claim 1, wherein, the plurality of types of transmissive patterns comprise a red light transmissive pattern, a blue light transmissive pattern and a green light transmissive pattern, the holes constituting the red light transmissive pattern have hole diameters in a hole diameter range of about 400 nm˜about 470 nm, the holes constituting the green light transmissive pattern have hole diameters in a hole diameter range of about 280 nm˜about 310 nm, and, the holes constituting the blue light transmissive pattern have hole diameters in a hole diameter range of about 200 nm˜about 270 nm.

7. (canceled)

8. A display apparatus, comprising: the color film substrate assembly of claim 1, a liquid crystal cell and a backlight source; wherein,
the color film substrate assembly is between the liquid crystal cell and the backlight source.

9. The display apparatus of claim 8, wherein, the liquid crystal cell comprises a second substrate, a third substrate, a first electrode layer, a second electrode layer and a liquid crystal layer;
the first electrode layer is on a surface of the third substrate facing towards the second substrate, the second electrode layer is on a surface of the second substrate facing towards the third substrate, and the liquid crystal layer is between the first electrode layer and the second electrode layer.

10. The display apparatus of claim 9, wherein,
a first surface of the first substrate faces towards the backlight source; or, the first surface of the first substrate faces away from the backlight source.

11. The display apparatus of claim 8, wherein, the liquid crystal cell comprises the first substrate, a second substrate, a first electrode layer, a second electrode layer and a liquid crystal layer;
the first electrode layer is on a second surface of the first substrate, the second surface and the first surface being two opposite surfaces of the first substrate, the second electrode layer is on a surface of the second substrate facing towards the first substrate, and the liquid crystal layer is between the first electrode layer and the second electrode layer.

12. The display apparatus of claim 8, wherein, the liquid crystal cell comprises the first substrate, an insulation layer, a second substrate, a first electrode layer, a second electrode layer and a liquid crystal layer;
the insulation layer is on a first surface of the first substrate, the first electrode layer is on the insulation layer, the second electrode layer is on a surface of the second substrate facing towards the first substrate, and the liquid crystal layer is between the first electrode layer and the second electrode layer.

13. The display apparatus of claim 8, wherein, the first electrode layer and the second electrode layer are transparent electrode layers.

14. The display apparatus of claim 8, wherein, the liquid crystal layer is formed by polymerizing a composition comprising negative liquid crystals, polymerizable monomers and a photoinitiator.

15. A method of manufacturing a color film substrate assembly, the method comprising:
providing a first substrate; and
forming a color film layer on a first surface of the first substrate, wherein, the color film layer is provided with a plurality of types of transmissive patterns distributed periodically, and each of the transmissive patterns in a same type of transmissive patterns is constituted by a plurality of holes being in an array arrangement and having hole diameters in one hole diameter range, holes in the plurality of types of transmissive patterns have hole diameters in different hole diameter ranges, and each of the same type of transmissive patterns is capable of transmitting a light of one color therethrough.

16. The method of claim 15, wherein, the step of forming a color film layer on a first surface of the first substrate, further comprises:
coating a metal layer onto the first surface of the first substrate; and
etching holes, which have hole diameters in a plurality of hole diameter ranges, in the metal layer, to obtain the plurality of types of transmissive patterns.

17. The method of claim 15, wherein, the plurality of types of transmissive patterns comprise a red light transmissive pattern, a blue light transmissive pattern and a green light transmissive pattern.

18. The method of claim 17, wherein, the holes constituting the red light transmissive pattern have hole diameters in a hole diameter range of about 400 nm˜about 470 nm, the holes constituting the green light transmissive pattern have hole diameters in a hole diameter range of about 280 nm˜about 310 nm, and, the holes constituting the blue light transmissive pattern have hole diameters in a hole diameter range of about 200 nm˜about 270 nm.

19. The display apparatus of claim 8, wherein, in the color film substrate assembly,
the metal material comprises at least one of aluminum, gold, silver, platinum, copper, nickel, palladium, zinc, iron and chromium;
the color film layer has a thickness of about 100 nm˜about 300 nm; and
the holes have a shape of a circle or a regular polygon.

20. The display apparatus of claim 8, wherein, in the color film substrate assembly,
the plurality of types of transmissive patterns comprise a red light transmissive pattern, a blue light transmissive pattern and a green light transmissive pattern, the holes constituting the red light transmissive pattern have hole diameters in a hole diameter range of about 400 nm˜about 470 nm, the holes constituting a green light transmissive pattern have hole diameters in a hole diameter range of about 280 nm˜about 310 nm, and the holes constituting the blue light transmissive pattern have hole diameters in a hole diameter range of about 200 nm˜about 270 nm.

21. The method of claim 16, wherein,
the metal material comprises at least one of aluminum, gold, silver, platinum, copper, nickel, palladium, zinc, iron and chromium;
the color film layer has a thickness of about 100 nm˜about 300 nm; and
the holes have a shape of a circle or regular polygon.
